(19) United States
(12) Patent Application Publication
(10) Pub. No.: US 2026/0362145 A1
(43) Pub. Date: Nov. 12, 2026

(54) FILTERING DEVICE IDENTIFIERS

(71) Applicant: Lenovo (United States) Inc., Morrisville, NC (US)

(72) Inventors: Genadi Velev, Darmstadt (DE); Andreas Kunz, Ladenburg (DE)

(73) Assignee: Lenovo (United States) Inc., Morrisville, NC (US)

(21) Appl. No.: 19/203,090

(22) Filed: May 8, 2025

(51) Int. Cl. H04W 12/40; G16Y 40/50; H04W 12/106

(52) U.S. Cl. CPC H04W 12/40; G16Y 40/50; H04W 12/106

(57) ABSTRACT

Various aspects of the present disclosure relate to filtering device identifiers. An ambient Internet of things (AIoT) service request that includes at least one AIoT device identifier (ID) is received. One or more parameters for modifying the at least one AIoT device ID for privacy protection is determined. Information based at least in part on the one or more parameters is transmitted.

### TECHNICAL FIELD

The present disclosure relates to wireless communications, and more specifically to filtering device identifiers.

### BACKGROUND

A wireless communications system may include one or multiple network communication devices, such as base stations, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

An NE (e.g., a base station) for wireless communication is described. The NE may be configured to, capable of, or operable to perform one or more operations as described herein. For example, the NE may be configured to, capable of, or operable to receive an ambient Internet of things (AIoT) service request that includes at least one AIoT device identifier (ID); determine one or more parameters for modifying the at least one AIoT device ID for privacy protection; and transmit information based at least in part on (or comprising) the one or more parameters.

A processor (e.g., a standalone processor chipset, or a component of an NE (e.g., a base station)) for wireless communication is described. The processor may be configured to, capable of, or operable to perform one or more operations as described herein. For example, the processor may be configured to, capable of, or operable to receive an AIoT service request that includes at least one AIoT device ID; determine one or more parameters for modifying the at least one AIoT device ID for privacy protection; and transmit information based at least in part on (or comprising) the one or more parameters.

A method performed or performable by an NE (e.g., a base station) for wireless communication is described. The method may include receiving an ambient Internet of things (AIoT) service request that includes at least one AIoT device identifier (ID); determining one or more parameters for modifying the at least one AIoT device ID for privacy protection; and transmitting information based at least in part on the one or more parameters.

In some implementations of the NE, the processor, and the method described herein, to determine the one or more parameters, the NE, processor, and method may further be configured to, capable of, performed, performable, or operable to reduce a number of AIoT devices that are identified by the one or more parameters. In some implementations of the NE, the processor, and the method described herein, the at least one AIoT device ID comprises at least one AIoT device permanent ID. In some implementations of the NE, the processor, and the method described herein, the at least one AIoT device ID is identified by filter information included in the AIoT service request.

In some implementations of the NE, the processor, and the method described herein, to transmit the information, the NE, processor, and method may further be configured to, capable of, performed, performable, or operable to transmit the information to an AIoT reader device. In some implementations of the NE, processor, and method described herein, the NE, processor, and method may further be configured to, capable of, performed, performable, or operable to receive a response from an AIoT reader device that includes one or more device temporary IDs of one or more AIoT devices identified by the information.

In some implementations of the NE, processor, and method described herein, the NE, processor, and method may further be configured to, capable of, performed, performable, or operable to transmit a request message that includes an indication to provide at least one AIoT device permanent ID corresponding to the at least one AIoT device ID, or an indication to provide at least one AIoT device temporary ID corresponding to the at least one AIoT device ID.

In some implementations of the NE, processor, and method described herein, the NE, processor, and method may further be configured to, capable of, performed, performable, or operable to receive the at least one AIoT device permanent ID, or the at least one AIoT device temporary ID. In some implementations of the NE, the processor, and the method described herein, the one or more parameters include a starting bit location and a number of bits that are indicative of an ID type field and a domain information field included in an AIoT device permanent ID corresponding to the at least one AIoT device.

In some implementations of the NE, the processor, and the method described herein, the one or more parameters include a starting bit location and a number of bits that are indicative of a third party identifier field included in an AIoT device permanent ID corresponding to the at least one AIoT device. In some implementations of the NE, the processor, and the method described herein, the one or more parameters include a first starting bit location and a first number of bits that are indicative of a first portion of an AIoT device permanent ID corresponding to the at least one AIoT device, and a second starting bit location and a second number of bits that are indicative of a second portion of the AIoT device permanent ID corresponding to the at least one AIoT device.

In some implementations of the NE, the processor, and the method described herein, the first portion identifies a public land mobile network (PLMN) ID field of the AIoT device permanent ID and a network identifier (NID) field of the AIoT device permanent ID, and where the second portion identifies part of an identification information field of the AIoT device permanent ID. In some implementations of the NE, the processor, and the method described herein, the one or more parameters include a starting bit location and a first number of bits that are indicative of a third party identifier field and a portion of an identification information field included in an AIoT device permanent ID corresponding to the at least one AIoT device.

A device (e.g., a UE or AIoT device) for wireless communication is described. The device may be configured to, capable of, or operable to perform one or more operations as described herein. For example, the apparatus may be configured to, capable of, or operable to receive a message that includes information generated based at least in part on one or more parameters; and transmit, based at least in part on the information matching a permanent ID of the device, a response to the message.

A processor (e.g., a standalone processor chipset, or a component of a UE or of an AIoT device) for wireless communication is described. The processor may be configured to, capable of, or operable to perform one or more operations as described herein. For example, the processor may be configured to, capable of, or operable to receive a message that includes information generated based at least in part on one or more parameters; and transmit, based at least in part on the information matching a permanent ID of the device, a response to the message.

A method performed or performable by an apparatus (e.g., a UE or AIoT device) for wireless communication is described. The method may include receiving a message that includes receiving a message that includes information generated based at least in part on one or more parameters; and transmitting, based at least in part on the information matching a permanent ID of the device, a response to the message.

In some implementations of the device, the processor, and the method described herein, the device comprises an AIoT device, and the response to the message includes at least one of a temporary ID of the device, cryptographic nonce information, or a message authentication code. In some implementations of the device, the processor, and the method described herein, the one or more parameters include a starting bit location and a number of bits that are indicative of an ID type field and a domain information field included in the permanent ID of the device.

In some implementations of the device, the processor, and the method described herein, the one or more parameters include a starting bit location and a number of bits that are indicative of a third party identifier field included in the permanent ID of the device. In some implementations of the device, the processor, and the method described herein, the one or more parameters include a first starting bit location and a first number of bits that are indicative of a first portion of the permanent ID of the device, and a second starting bit location and a second number of bits that are indicative of a second portion of the permanent ID of the device.

In some implementations of the device, the processor, and the method described herein, the first portion identifies a PLMN ID field of the permanent ID of the device and a NID field of the permanent ID of the device, and where the second portion identifies part of an identification information field of the permanent ID of the device. In some implementations of the device, the processor, and the method described herein, the one or more parameters include a starting bit location and a first number of bits that are indicative of a third party identifier field and a portion of an identification information field included in the permanent ID of the device.

### BRIEF DESCRIPTION OF THE DRAWINGS

FIG. 1 illustrates an example of a wireless communications system in accordance with aspects of the present disclosure.

FIGS. 2 and 3 illustrate example connectivity topologies in accordance with aspects of the present disclosure.

FIGS. 4 and 5 illustrate example system architectures supporting AIoT devices in accordance with aspects of the present disclosure.

FIG. 6 illustrates an example of an AIoT device identifier in accordance with aspects of the present disclosure.

FIGS. 7 through 10 illustrate examples of filtering information applied to an AIoT device permanent ID in accordance with aspects of the present disclosure.

FIGS. 11A and 11B illustrate an example signaling flow of an inventory procedure in accordance with aspects of the present disclosure.

FIG. 12 illustrates an example of a device in accordance with aspects of the present disclosure.

FIG. 13 illustrates an example of a processor in accordance with aspects of the present disclosure.

FIG. 14 illustrates an example of an NE in accordance with aspects of the present disclosure.

FIG. 15 illustrates a flowchart of a method performed by a device in accordance with aspects of the present disclosure.

FIG. 16 illustrates a flowchart of a method performed by an NE in accordance with aspects of the present disclosure.

### DETAILED DESCRIPTION

A wireless communication system (also referred to as a wireless network), for example, a 5G system (5GS), can support cellular Internet of things (IoT) services to devices with reduced capabilities. Some of these devices with reduced capabilities are simplified devices referred to as ambient IoT (AIoT) devices. AIoT devices are a class of IoT devices that are powered by harvesting energy from various sources such as radio frequency (RF) energy, solar energy, wind energy, and so forth. In some scenarios, AIoT devices can harvest RF energy from transmissions made by the wireless network. In contrast to traditional IoT devices, AIoT devices do not rely on batteries and typically have limited energy storage capabilities, such as utilizing an internal capacitor for energy storage.

The RF energy harvesting allows ambient IoT devices to harvest energy from RF signals available in their environment, such as RF signals transmitted from mobile networks or from nearby Wi-Fi networks. The RF energy harvesting allows for self-sustainable wireless IoT networks and also allows the energy harvesting performance of a Wi-Fi-based IoT network to be analyzed.

For RF energy harvesting, in order for an AIoT device to transmit data the AIoT device receives an RF signal that provides sufficient energy to power the AIoT device. This RF signal is also referred to as a trigger signal or a trigger message. The trigger message can be sent or transmitted, for example, by a base station acting as an AIoT reader or a UE acting as an AIoT reader. Whether a base station or a UE, the AIoT reader is typically assumed to be in close proximity to the AIoT device.

Each AIoT device has an identifier that allows the AIoT device to be distinguished from other AIoT devices. This identifier may also be referred to as a permanent ID of the AIoT device or an AIoT device permanent ID. An application function (AF) (or the AIoT service customer) can have service requests sent to AIoT devices, such as requests to perform inventory procedures or command procedures. An inventory procedure collects information identifying AIoT devices in the wireless communications system (e.g., indicating device types, locations, vendors, and so forth), and a command procedure provides data or control information to an AIoT device or receives data or control information from an AIoT device (e.g., reads data from an AIoT device, writes data to an AIoT device).

The AF may send a service request message (e.g., for an inventory or a command procedure) for a specific AIoT device and the message may contain the complete AIoT device permanent ID. In order to protect the privacy of the AIoT device over the air interface, it is not recommended or desirable to transmit the complete AIoT device permanent ID over the air interface, e.g., in a paging message to the AIoT devices. In one possible solution, a device temporary ID can be transmitted, similar to how a globally unique temporary identifier (GUTI) is used to calculate the temporary ID transmitted over the air in case of UE communication over Uu interface. However, the AIoT device does not register with the network, and it is difficult to synchronize the device temporary ID.

The techniques discussed herein describe AIoT service requests having associated AIoT device ID information. The AIoT device ID information can be one or more AIoT device IDs (e.g., one or more complete AIoT device permanent IDs) or requested filter information (e.g., to identify a group of multiple AIoT devices). A complete AIoT device ID (e.g., a complete AIoT device permanent ID) refers to the entire ID (e.g., all bits of the AIoT device permanent ID) as opposed to just a portion (less than all) of the bits of the ID. The requested filter information is filter information requested by an AF (or an AIoT service consumer), e.g., to select or identify a group of AIoT devices, which may be used as-is or may be modified. Filtered information for a request is generated based on filter information applied to the AIoT device ID information (e.g., by applying a filter mask to the complete AIoT device ID). The filter mask provides an indication of which one or more portions (e.g., which one or more bits) of the complete AIoT device ID is to be transmitted to the AIoT devices. Accordingly, the filtered information is a filtered version or an anonymized version of the complete AIoT device ID, as certain portions of the complete AIoT device ID (as indicated by the filter mask) are not included in the derived filter information. An anonymized version of an AIoT device ID (also referred to as an anonymized AIoT device ID) is a version of the AIoT device ID that has some information or portions (e.g., some bits) removed, deleted, or altered so that the anonymized AIoT device ID does not uniquely identify the AIoT device. The derived filter information can then be transmitted to the AIoT devices.

Using the techniques discussed herein, the AF (or the AIoT service consumer) sends to the network (e.g., to an AIoT function (AIOTF)) a request message for inventory of one or more AIoT devices. Filter information (also referred to as one or more parameters) is applied (e.g., by the AIOTF or an AIoT data management (ADM)) to mask or hide part of the AIoT device permanent ID. If the AF uses filter information to mask or hide part of the AIoT device permanent ID, the AIOTF uses the same filter information to transmit the inventory request message to the AIoT readers. By using the filtering information applied to the AIoT device permanent ID, the privacy of the AIoT device can be protected because the complete device ID is not revealed over the air interface.

By using the filter information, the techniques discussed herein avoid problems that can arise in situations where the AIoT device and the network negotiate a mechanism to create AIoT device temporary IDs. With such techniques, by applying the same mechanism in the AIoT device and in the network to generate a new AIoT device temporary ID, it is assumed that the use of AIoT devices temporary ID can be synchronized. However, as the AIoT devices may lack energy and may miss a signaling exchange triggered by the network, it is possible that the mechanism in the AIoT device and in the network become asynchronous and the AIoT device temporary ID generation mechanism creates mis-matched temporary IDs. Furthermore, for a very first signaling interaction with the AIoT device, the network (e.g., the ADM) may not have initialized the AIoT device temporary ID generation mechanism yet, and thus may not be able to generate an AIoT device temporary ID. The techniques discussed herein provide a new solution to apply anonymization of the AIoT devices permanent ID when the ID is transmitted over the air interface (e.g., in a paging message).

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

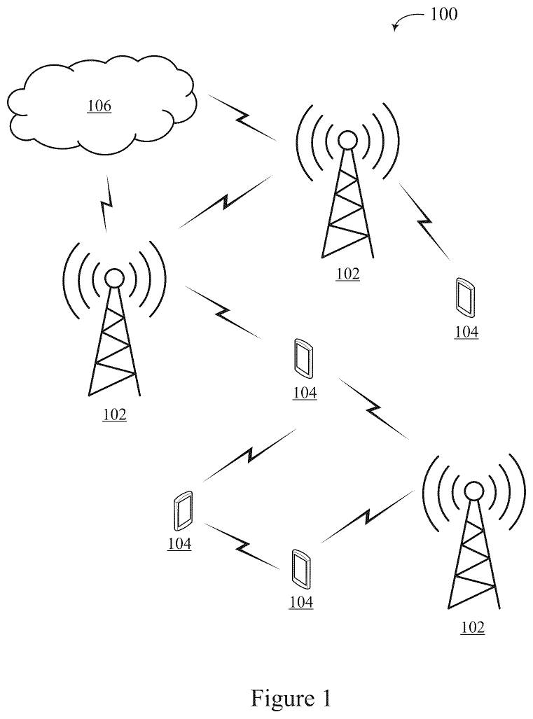

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

One or more of the NEs 102 and/or the UEs 104 can be AIoT reader devices. An AIoT reader device refers to a device that receives, obtains, senses signaling from an AIoT device. An AIoT device in the wireless communications system 100 harvests energy (e.g., RF energy from other devices in the wireless communications system 100) to power the AIoT device and communicate (e.g., transmit, send, signal) data or information that is received, obtained, or sensed by the AIoT reader device.

An Ambient IoT device refers to a low-power (e.g., self-powered) sensor or device, which is typically small and/or low-cost. For example, Ambient IoT devices may include an energy harvester with an output power of from 1 microwatt (μW) to a few hundreds of μW. Ambient IoT devices also typically do not include a subscriber identity module (SIM) card. There are different topologies and deployment scenarios of Ambient IoT devices as discussed in more detail below.

In one or more implementations, the Ambient IoT device may be a sensor (e.g., a tag), an actuator, an appliance, or another device capable of connecting to a wireless network. In some examples, the Ambient IoT device is categorized according to a set of components and/or capabilities of the Ambient IoT devices, where the categories include one or more of an active Ambient IoT device category, a semi-passive Ambient IoT device category, and/or a passive Ambient IoT device category. An active Ambient IoT device includes a power source and an active radio frequency component, such as a transmitter and/or receiver component, for signal generation. The transmitter and/or receiver component may include one or more antennas for transmitting and receiving signaling. A semi-passive Ambient IoT device may have energy storage capabilities but may not include an active radio frequency component for signal generation. A passive Ambient IoT device may not have energy storage capabilities or an active radio frequency component.

In some cases, semi-passive Ambient IoT devices and passive Ambient IoT devices use backscattering techniques and/or energy harvesting for transmitting and/or receiving transmissions. In variations, an active Ambient IoT device may use a transmitter and/or receiver component for transmitting or receiving transmissions and/or may use backscattering techniques for transmitting and/or receiving transmissions. Semi-passive Ambient IoT devices may use the stored energy to amplify a signal when using backscattering techniques. Backscattering techniques include receiving signaling from a source device (e.g., a node such as an intermediate node) and modulating a reflection of the incoming signaling towards a destination device (e.g., a reader node such as an intermediate node). Thus, the Ambient IoT device may not use an active receiver and/or transmitter component for receiving and transmitting signaling, which reduces a power consumption level of the device.

In some examples, the Ambient IoT device may be capable of energy harvesting using energy harvesting techniques. For example, the Ambient IoT device may extract energy from transmission waves from a source device (e.g., an NE) to power the Ambient IoT device. The source device may transmit the signaling using a continuous wave waveform in which the signaling has a constant amplitude and frequency and/or a carrier wave waveform in which the signaling has a periodic variation in amplitude, duration, and position. Signaling transmitted using a continuous wave waveform may be referred to as a continuous wave transmission, while signaling transmitted using a carrier wave waveform may be referred to as a carrier wave transmission. If the Ambient IoT device includes an energy storage component, then the Ambient IoT device may store the extracted energy for later use (e.g., to amplify a reflection of signal or to generate a new signal).

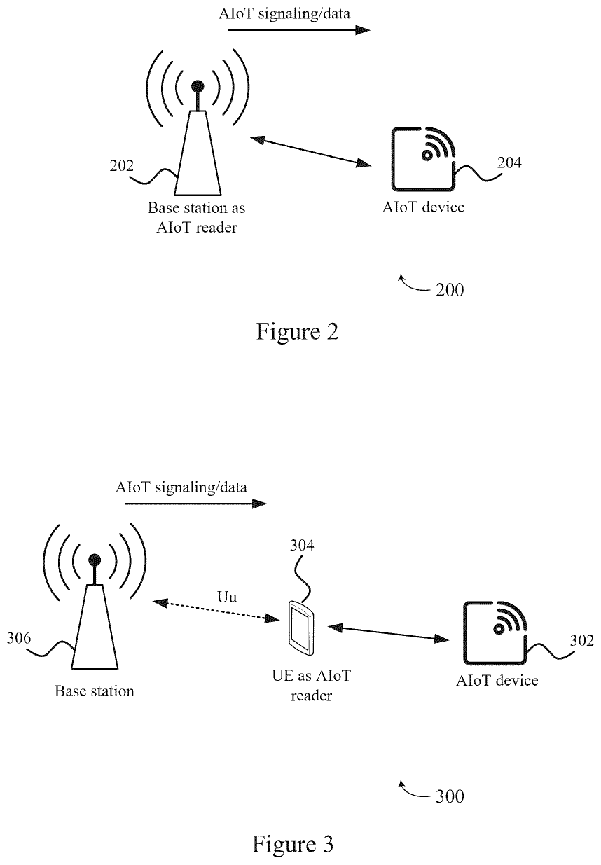

Different connectivity topologies can be used that describe how an AIoT device can communicate with a network (e.g., a 5GS mobile network or wireless communications system 100). Examples of these connectivity topologies can include Topology 1 illustrated in FIG. 2 below and Topology 2 illustrated in FIG. 3 below for AIoT networks and devices. In both Topology 1 and Topology 2, the AIoT device may be provided with a carrier wave from one or more other nodes inside or outside the topology. The links in each topology may be bidirectional or unidirectional.

FIG. 2 illustrates an example connectivity topology 200 in accordance with aspects of the present disclosure. The connectivity topology 200, also referred to as Topology 1, includes a base station 202 communicating directly with an AIoT device 204 (e.g., base station 202 reader↔AIoT device 204). The communication between the base station 202 reader and the AIoT device 204 includes AIoT data and/or signaling.

FIG. 3 illustrates an example connectivity topology 300 in accordance with aspects of the present disclosure. The connectivity topology 300, also referred to as Topology 2, includes an AIoT device 302 communicating bidirectionally with a UE 304 acting as an AIoT reader between the AIoT device 302 and a base station 306. This communication can be denoted as “base station↔UE as AIoT reader↔AIoT device.” The UE 304 acting as an AIoT reader is assumed to be a UE (e.g., a UE 104 of FIG. 1) capable of transmitting and receiving data/signaling with the AIoT device 302 (e.g., a UE capable of AIoT communication).

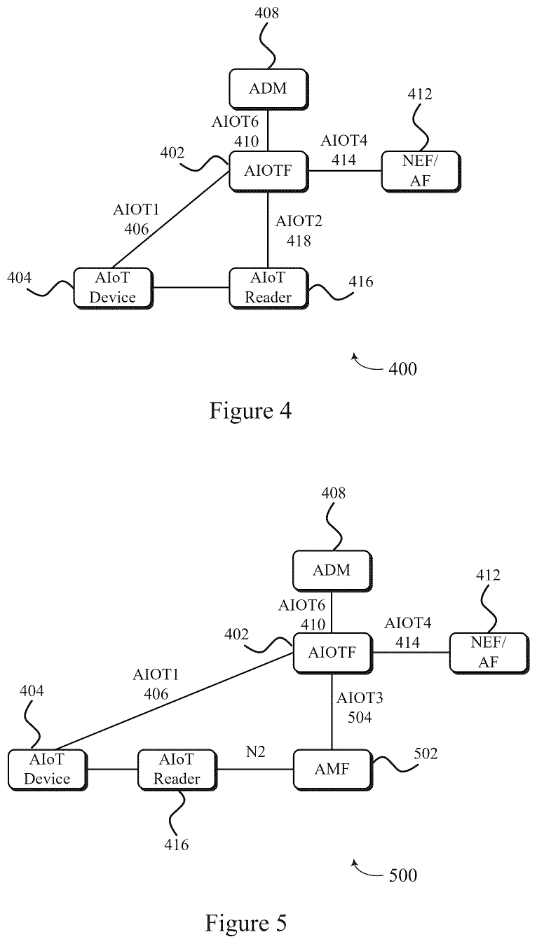

FIG. 4 illustrates an example system architecture 400 supporting AIoT devices in accordance with aspects of the present disclosure. The system architecture 400, also referred to as a direct path or direct connectivity architecture, includes an AIOTF 402 that communicates (e.g., transmits, sends, signals, receives, obtains) data or control information with an AIoT device 404 via an AIOT1 interface 406, with an ADM 408 via an AIOT5 interface 410, with a network exposure function (NEF)/AF 412 via an AIOT4 interface 414, and with an AIoT reader 416 (also referred to as an AIoT RAN or an AIoT RAN node) via an AIOT2 interface 418. The example system architecture 400 illustrates a direct path in which the AIOTF 402 communicates directly with the AIoT reader 416 via the AIOT2 interface in order to perform AIoT operations.

The AIoT device 404 and the AIOTF 402 exchange data or control information via the AIOT1 interface 406 (also referred to as a reference point). The AIOTF 402 communicates (e.g., transmits, sends, signals, receives) directly with the AIoT reader 416 via the AIOT2 interface 418 in order to perform AIoT operations. The AIOT1 interface 406 is used to transfer AIoT data (e.g., data to be written to the AIoT device 404 or read from the AIoT device 404) between the AIoT device 404 and the AIOTF 402. The AIOTF 402 is a CN function that supports AIoT services (e.g., inventory and/or command requests). The AIOTF 402 selects the AIoT readers, such as AIoT reader 416. The AIoT reader 416 supports one or more base station readers, and one base station reader serves a defined service area within the AIoT RAN. The AIOTF 402 receives an AIoT service request from the NEF/AF 412 and triggers the AIoT reader 416 to perform AIoT service operations towards the targeted AIoT device(s) 404. The AF is, for example, the AIoT service consumer.

The ADM 408 is a function that is responsible for the management of AIoT device profile data. The ADM 408 is similar to a unified data management (UDM)/unified data repository (UDR) where the UE data profiles and subscription data is stored, but the ADM 408 manages and stores profiles of AIoT device such as the AIoT device permanent ID, the corresponding credentials of the AIoT device and possible last known location of the AIoT device. The AIOTF 402 exchanges or communicates (e.g., transmits, sends, signals, receives, obtains) data or control information with the ADM 408 via the AIOT6 interface 410.

Any AIoT application can communicate (e.g., transmit, send, signal, receive, obtain) AIoT data or control information with the AIOTF 402 via the AIOT4 interface 414. In a case of an untrusted AF, the AF exchanges with the NEF and the NEF forwards the signaling or data to the AIOTF 402.

FIG. 5 illustrates an example system architecture 500 supporting AIoT devices in accordance with aspects of the present disclosure. The system architecture 500 includes an AIOTF 402, an AIoT device 404, an ADM 408, an NEF/AF 412, an AIoT reader 416, an AIOT1 interface 406, an AIOT6 interface 410, and an AIOT4 interface 414, similar to the system architecture 400 of FIG. 4. The system architecture 500 differs from the system architecture 400 in that the system architecture 500, also referred to as an indirect path or indirect connectivity architecture, in that the AIOTF 402 communicates directly with the AIoT reader 416 via an AMF 502, where the interface between the AIOTF 402 and the AMF 502 is an AIOT3 interface 504.

Returning to FIG. 1, AIoT devices in the wireless communications system 100 are allocated an identifier that allows the AIoT device to be distinguished from other AIoT devices within the wireless communications system 100. In one or more implementations, this identifier is a globally unique AIoT device permanent ID. An AIoT device permanent ID is assigned, for example, by an operator or by a third party. The AIoT device permanent ID is used to identify AIoT devices and locate the entity (e.g., in the wireless communications system 100) where the AIoT device related information is stored.

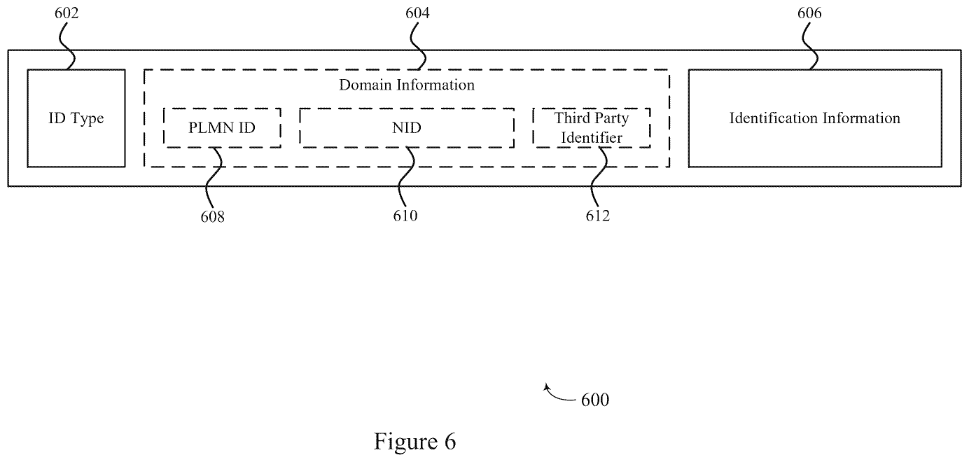

FIG. 6 illustrates an example of an AIoT device identifier 600 in accordance with aspects of the present disclosure. The AIoT device identifier 600 is, for example, an AIoT device permanent ID. The AIoT device identifier 600 includes an ID type 602 field, a domain information 604 field, and an identification information 606 field. The ID type 602 may include information indicating whether some of the domain information 604 is included, e.g., whether a PLMN ID 608 field, an NID 610 field, or a third party identifier 612 field are included. Further, the ID type 602 may indicate whether the identification information 606 is of type electronic product code (EPC) or unstructured information. The domain information 604 includes none, one, or more of the PLMN ID 608 (e.g., mobile country code (MCC) and mobile network code (MNC)) as specified in 3rd generation partnership project (3GPP) technical specification (TS) 23.003 when the information in the ID type 602 indicates it is included, an NID as specified in 3GPP TS 23.003 when the information in the ID type 602 indicates it is included, or a third party identifier used to identify a third party when the information in the ID type 602 indicates it is included.

The identification information 606 is used to distinguish different AIoT Devices within the scope identified by the domain information 604 (if available). It may be assumed that the length of the identification information 606 can be, for example, 96 bits or 128 bits. The identification information 606 may contain: 1) an EPC that provides a unique identity for every physical object anywhere in the world; one representation of an EPC is a uniform resource identifier (URI)—the ‘pure-identity URI’ that is intended for use when referring to a specific physical object in communications about EPCs among information systems and business application software; or 2) unstructured information, where the contents is defined by the allocator.

The size of an AIoT device permanent ID may take several hundreds of bits, e.g., up to 600 bits maximum. The AIoT device permanent ID is used by the application provider (e.g., NEF/AF 412 in FIG. 4 or FIG. 5) and in the 5GS to identify an AIoT device. The AF and the 5GS may use a bit-mask (also known as “filtering information” or a “filtering mask”) on the AIoT device permanent ID.

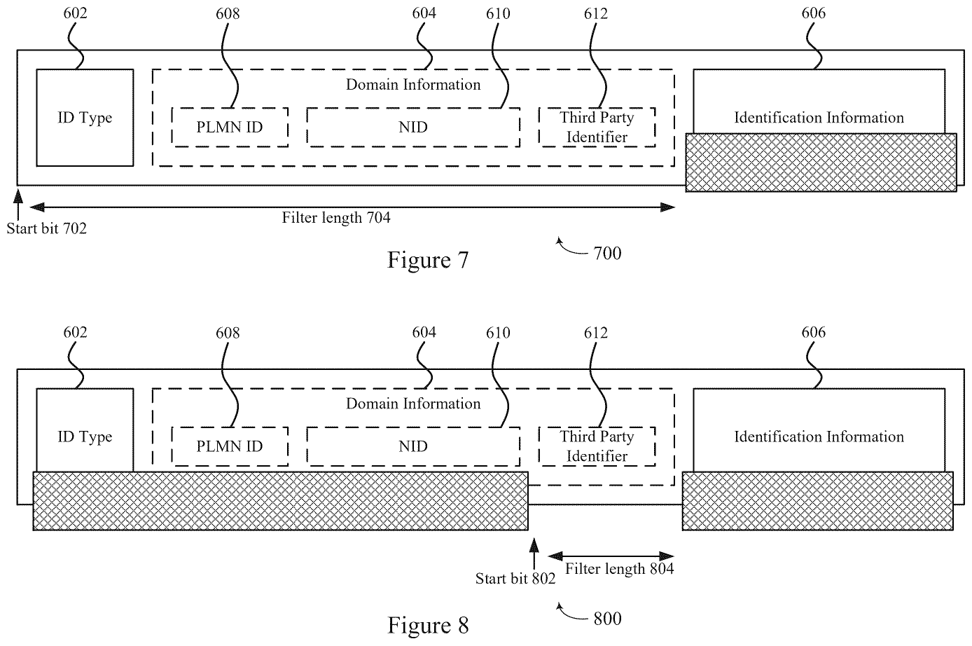

If the AF desires to target or identify multiple devices, the AF can use the filtering information. In one example, by applying filtering information, a group of AIoT devices can be identified as discussed below with reference to FIG. 7-10, and by this the filter information can be also referred as group ID.

In accordance with the techniques discussed herein, if the AIOTF receives a service request that in one example use case includes AIoT device identification information containing a complete AIoT device ID, such as an AIoT device permanent ID (or an AIoT device temporary permanent ID) and the AIOTF is to generate a service request message (e.g., an inventory request message) to the RAN for transmission over the air interface, the AIOTF determines to translate the complete AIoT Device ID into an anonymized ID in one of the following options. One option is the AIOTF may internally store a device temporary ID and may use it. Alternatively, or additionally, if the AIOTF does not store a device temporary ID, the AIOTF may send a request message to the ADM including the complete AIoT device ID and an indication that a device temporary ID corresponding to the complete AIoT device ID is requested. The ADM provides to the AIOTF a device temporary ID corresponding to the complete AIoT device ID.

In another example use case, if the device temporary ID is not available (e.g., at the AIOTF and/or at the ADM) or the device temporary ID is out of synchronization with the AIoT device (e.g., the device temporary ID cannot be used or is invalid), the AIOTF may determine to create filtering information (e.g., a filter mask or bit mask) to be applied to the complete AIoT device ID. In another example use case, the AIOTF may receive from the AF a list of multiple AIoT device permanent IDs for inventory service. Since the same AF sends the request, it is possible that the AIoT device permanent IDs overlap to some extent, e.g., the AIoT device permanent ID fields “ID Type” and “Domain information,” but also part of the “Identification information” are the same. It is more efficient if the AIOTF creates a filter information that applies to all (or at least some) of the AIoT device permanent IDs. In yet another example use case, the AIOTF may receive from the AF filter information which may result in a large number of devices responding, e.g., when the filter information includes only “Domain information” to which a large number of AIoT devices are associated. In order to limit the possible congestion of responding AIoT devices, and thus limit the number of devices which may potentially respond to the paging message, the AIOTF may increase the length of the filter information (e.g., limit the number of devices that would potentially match to the filter information). In such a case, the AIOTF may send several Inventory Request messages to the RAN reader. In other words, in one or more implementations this disclosure describes how an AIOTF can determine to create filtering information to be applied to 1) a complete AIoT device permanent ID in order to anonymize the complete AIoT device permanent ID or 2) to a requested filter information provided by the AF in order to limit the number of devices which may potentially respond to the paging message.

Due to the filter information, it is possible that multiple AIoT devices (e.g., besides the intended AIoT device) reply to the AIoT service request (e.g., inventory request), the AIOTF implements a further technique to identify the specific AIoT device. This technique includes the following. The received replies from the AIoT devices may include an AIoT device temporary ID and additional cryptographic nonce information (e.g., a random or pseudo-random number). The AIOTF may include functionality to verify and translate the AIoT device temporary IDs to the corresponding AIoT device permanent IDs. Alternatively, or additionally, the AIOTF may send all received AIoT device temporary IDs and the nonce information to the ADM with a request to provide the AIoT device permanent IDs corresponding to the AIoT device temporary IDs. After receiving the reply from the ADM, the AIOTF determines which of the AIoT device permanent IDs provided by the ADM matches with the AIoT device permanent ID as received initially from the AF or AIoT service consumer. If the AIOTF determines a matching AIoT device permanent ID, the AIOTF determines that the specific AIoT device has replied to the service request. The AIOTF can store a context for each AIoT device at least for the time duration from receiving the AIoT service request from the AF until the completion of the AIoT procedure and reporting back the result to the AF. The AIOTF uses the stored AIoT device context (e.g., containing the original AIoT Identification Information) and the AIOTF considers this original AIoT Identification Information when processing the received inventory responses like AIOT NAS message. For example, the AIOTF may translate back the AIoT Device ID based on the filter information applied to the inventory request message, or to aggregate or filter out the inventory report messages.

The anonymized ID is created to protect the privacy of the complete AIoT Device ID (e.g., the AIoT device permanent ID). The filter information (or filter mask, or bit mask) that is applied to the AIoT device permanent ID can be one or more filter elements or bit masks (or bit mask elements) that may apply on or to different parts of the AIoT device permanent ID. Each filter element may start at a certain bit and have a certain length (a number of bits). In one or more implementations, the mask identifies the information that the AIoT device uses to compare with its AIoT device permanent ID. In the examples of FIG. 7-10 below, the non-cross-hatched area is the filter information (or filter mask). Alternatively, or additionally, the mask identifies the information that is filtered-out (or removed) from the AIoT device permanent ID. In the examples of FIG. 7-10 below, the cross-hatched area is the filter information (or filter mask). This means that the AIoT device uses the other non-filtered information to compare with its AIoT device permanent ID.

FIG. 7-10 illustrate several examples of filtering information. In the examples of FIG. 7-10, the cross-hatched area(s) of the ID are filtered out of the device ID, e.g., the cross-hatched areas are not used to identify the AIoT devices. FIG. 7-10 are discussed with reference to elements of FIG. 6.

FIG. 7 illustrates an example 700 of filtering information applied to an AIoT device permanent ID in accordance with aspects of the present disclosure. In the example 700, the ID type 602 and the domain information 604 are used to identify any device whose device ID shares the same ID type and the domain information. The start bit 702 of the filter information is 0, the filter length 704 is equal to the length of the fields “ID type” and “Domain information” and the value of the filter is equal to the value of the “ID type” and “Domain information.”

FIG. 8 illustrates an example 800 of filtering information applied to an AIoT device permanent ID in accordance with aspects of the present disclosure. In the example 800, only the third party identifier 612 (part of the domain information 604) is used to identify any device that has the 3rd party identifier. The start bit 802 of the filter information is XX (the first bit of the third party identifier 612, the filter length 804 is equal to the length of the field “Third Party Identifier” and the value of the filter is equal to the value of the “Third Party Identifier.”

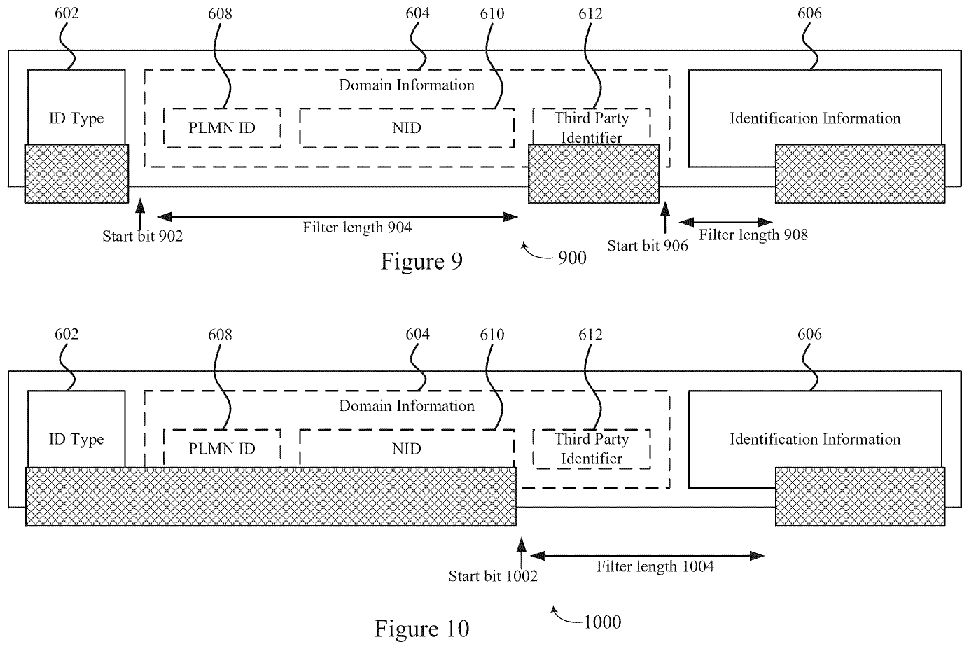

FIG. 9 illustrates an example 900 of filtering information applied to an AIoT device permanent ID in accordance with aspects of the present disclosure. In the example 900, the PLMN ID 608 and NID 610 of the domain information 604 together with a limited part of the beginning of the identification information 606 are used to identify the AIoT devices. Two filter information elements are illustrated in the example 900: a first filter information element has a start bit 902 (the first bit of the PLMN ID 608) and a filter length 904 that is equal to the length of the fields “PLMN ID” and “NID” and the filter value is equal to the value of the fields “PLMN ID” and “NID.” A second filter information element: has a start bit 906 (the first bit after the third party identifier 612 and a filter length 908 that is equal to the beginning of the “Identification information” (e.g., the beginning of the EPC ID) and the filter value is equal to the value of the beginning of the “Identification information.”

The example 900 illustrates two different filter information elements. However, it is to be appreciated that the filtering information can have any number of filter information elements.

FIG. 10 illustrates an example 1000 of filtering information applied to an AIoT device permanent ID in accordance with aspects of the present disclosure. In the example 1000, only the third party identifier 612 (part of the domain information) and a limited part of the beginning of the identification information 606 are used to identify the devices. The start bit 1002 of the filter information is the first bit after the NID 610 and a filter length 1004 of the filter information is equal to the length of the field “Third Party Identifier” and the beginning of the “Identification information” (e.g., the beginning of the EPC ID) and the filter value is equal to the value of the “Third Party Identifier” field and the beginning of the “Identification information.”

The filter information (or filter mask or bit mask) is applied to the AIoT device permanent ID. In a specific example of applying the filter information and assuming a single mask element (e.g., as in the example 700 of FIG. 7), the filter information indicates the starting bit for the mask comparison, the length of the mask and the mask value. All AIoT devices receiving the filter information from the base station determines whether their unique AIoT device permanent ID matches with the received filter information. All matching AIoT devices consider themselves as selected for the triggered AIoT inventory operation. All non-matching AIoT devices do not take part in the triggered inventory operation.

In one or more implementations, the filter information is applied to the inventory procedure where the network (e.g., the base station) includes in the paging message the filter information. The AIoT device uses a temporary ID in the reply NAS message to the network (e.g., the AIoT reader). In the command procedure, the network (e.g., the base station) uses the same or a new temporary ID in the NAS message towards the AIoT device.

The filter information is known to various components of the wireless communications system, such as one or more of the AIOTF, the ADM, the AIoT reader, or the AIoT device. In one or more implementations, one or more components of the wireless communications system are configured with the filter information, such as by a NE 102 (e.g., a base station) communicating (transmitting, signaling, sending) configuration information (e.g., to an AIoT reader and/or an AIoT device) that indicates the filter information being used by the AIOTF and/or the ADM.

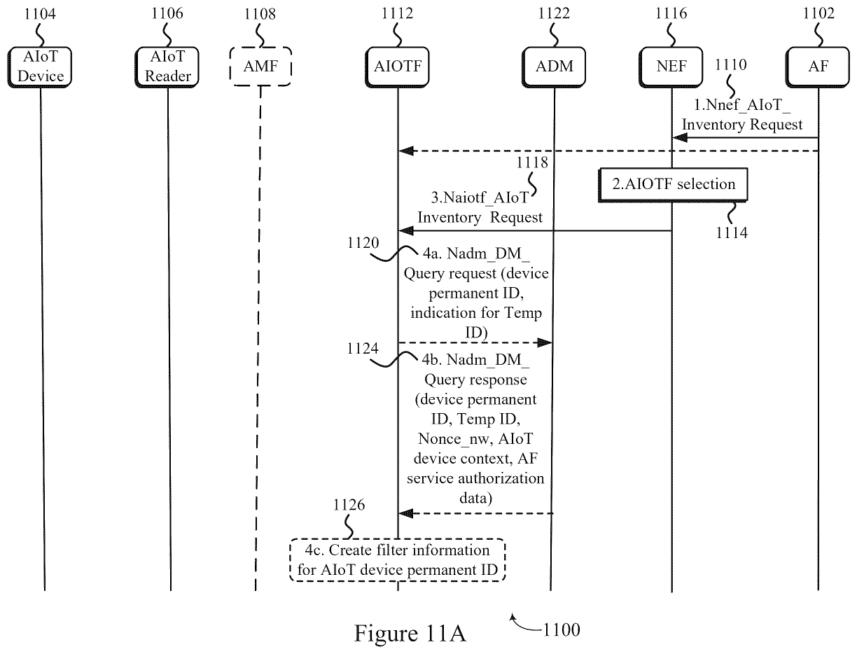

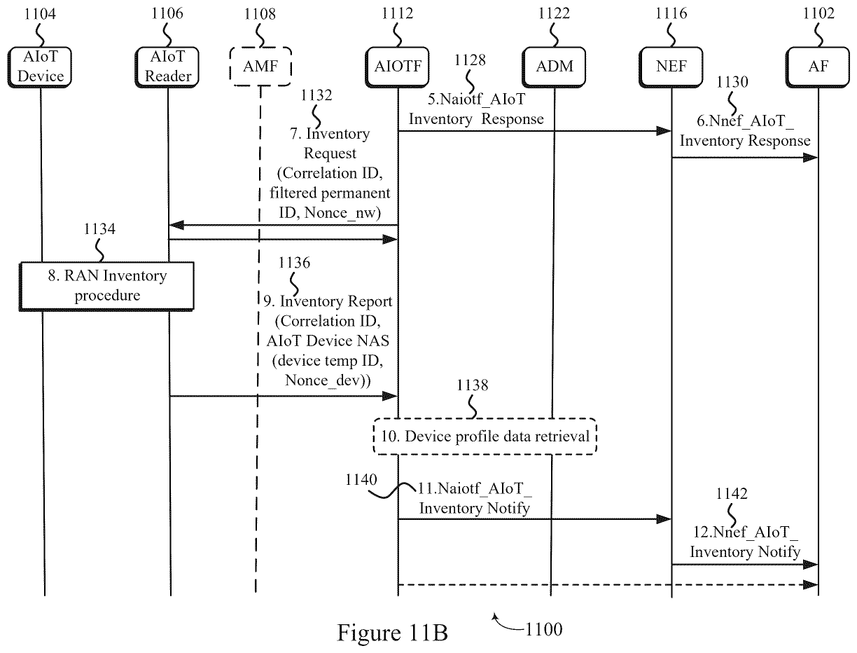

FIGS. 11A and 11B illustrate an example signaling flow 1100 of an inventory procedure in accordance with aspects of the present disclosure. The example signaling flow 1100 is a signaling flow for the transmission of an AIoT service request procedure (e.g., an inventory procedure) from an AF 1102 to an AIoT device 1104. An AIoT reader 1106 can be a RAN node (e.g., an NG-RAN base station) or a UE reader. An AMF 1108 is shown in the example signaling flow 1100 with a dotted line as the example signaling flow 1100 is common for both the direct path or direct connectivity architecture discussed above with reference to FIG. 4, and the indirect path or indirect connectivity architecture discussed above with reference to FIG. 5.

At 1110 (step 1), the AF 1102 may send a request message for inventory for one or more AIoT devices. The AF 1102 may invoke an Nnef_AIoT_Inventory request service operation and may include one or more of the parameters: AF ID, external target area information, information about the target one or more AIoT Devices (also referred to as AIoT Identification Information). The information about the one or more target AIoT Devices may include filtering information applied to the device ID (e.g., the AIoT device permanent ID), or include one or more complete AIoT device permanent IDs.

In one or more implementations of a trusted AF, if the AF 1102 is configured to directly discover, select, and contact the AIOTF 1112, the trusted AF 1102 may send the request message for inventory directly to the AIOTF 1112 as shown with an interrupted arrow.

At 1114 (step 2), the NEF 1116 may further authorize the AF request in order to determine whether the AF 1102 is eligible to use the requested network service(s). The NEF 1116 may determine the target area information, and select one or more AIOTFs to handle the service request.

At 1118 (step 3), the NEF 1116 transmits the inventory request message to the selected AIOTF 1112. The NEF 1116 may invoke the service operation Naiotf_AIoT_Inventory request including one or more of the parameters: AF ID, target area information, or information about the target one or more AIoT Devices. In one or more implementations it can be assumed that the information about the target one or more AIoT Devices includes one or more AIoT device permanent IDs.

At 1120 (step 4a), upon reception of the AIoT service request (e.g., inventory request), the AIOTF 1112 may verify the parameters included in the request, e.g., whether the service request is authorized for the requested one or more AIoT devices and/or for the target area. The AIOTF 1112 may send a request message to the ADM 1122 to request a device temporary ID. For example, the AIOTF 1112 may invoke Nadm_DM_Query request service operation and include one or more of the parameters AIoT device permanent ID or an indication for temporary ID request.

If the AIOTF 1112 does not store the device temporary ID, the AIOTF 1112 may send a request message to the ADM 1122 including the complete AIoT device ID (e.g., the AIoT device permanent ID) and an indication that the device temporary ID corresponding to the complete AIoT device ID is requested. The ADM 1122 provides to the AIOTF 1112 the device temporary ID corresponding to the complete AIoT device ID. If the AIoT service operation request cannot be processed, the AIOTF 1112 rejects the AIoT service operation request with an appropriate cause code in step 5 below, and then steps 7 through 12 are skipped.

At 1124 (step 4b), the ADM 1122 sends a response message to the AIOTF 1112. The ADM 1122 may invoke the service operation Nadm_DM_Query response and include one or more of the parameters: AIoT device permanent ID, device temporary ID, cryptographic nonce information from the network (e.g., Nonce_nw), AIoT device context, or AF service authorization data. The AIoT device temporary ID is stored in the ADM 1122 from previous service operation with the AIoT device, or the ADM 1122 generates the AIoT device temporary ID based on a pre-defined ID generation mechanism.

The parameter Nonce_nw is a cryptographic information to be used by the receiving AIoT device 1104 to generate a new temporary ID. The AIOTF 1112 performs Reader selection. The AIOTF 1112 may also use the last serving Reader ID as received from the AIoT device context information to assist with determining which AIoT readers to use for an AF 1102 requesting targeting for a specific AIoT Device 1104. If however, the ADM 1122 does not provide an AIoT device temporary ID corresponding to the AIoT device permanent ID, the AIOTF 1112 may determine to perform step 4c. below.

At 1126 (step 4c), if the AIoT device temporary ID is not available (e.g., at the AIOTF 1112 or at the ADM 1122) or the device temporary ID is out of synchronization with the AIoT device 1104 (e.g., the device temporary ID cannot be used or is invalid), the AIOTF 1112 may determine to create filtering information (e.g., a bit mask) to be applied to the complete AIoT device ID (e.g., the AIoT device permanent ID). The AIOTF 1112 may determine to create one or more filter information elements. When creating the filter information, the AIOTF 1112 takes into consideration to reduce (e.g., minimize) the number of AIoT devices which may potentially reply to the request (e.g., to the paging message). For example, the AIOTF 1112 may include in the filter information the whole or part of the domain information (e.g., the identification information is not used) as shown in example 700 of FIG. 2 and example 800 of FIG. 2. Then all AIoT devices belonging to the domain information will reply. A drawback to this is that too many AIoT devices may reply to the paging message. In another example, the AIOTF 1112 may include in the filter information part of the domain information and part of the identification information as shown in example 900 of FIG. 9 and example 1000 of FIG. 10. Since a part of the identification information is included in the filter information, then the possible number of responding devices is expected to be reduced.

It should be noted that in step 8 below, only those AIoT devices for which the filter information matches corresponding parts of their AIoT device permanent ID will respond to the request message.

If there are multiple complete AIoT device IDs included in the request message at 1110 (step 1.) or at 1118 (step 3.), the AIOTF 1112 may 1) generate the filter information for each complete AIoT device ID separately, or 2) the AIOTF 1112 may generate a common filter information for multiple complete AIoT device IDs. In the latter case, the AIOTF 1112 considers the common overlapping part of the complete AIoT device IDs and uses the common overlapping part as filter information that would avoid creating and sending multiple Inventory Request messages for each complete AIoT device ID in step 7 below, but instead a single message with the filter information would be send.

Alternatively, or additionally, the AIOTF 1112 may determine to apply filtering information based on further conditions besides the conditions described above. For example, in some cases the request from the AF 1102 provides a complete AIoT device permanent ID and there is filtering information included in the AF authorization data that the AIOTF 1112 receives from the ADM 1122. In such cases, the AIOTF 1112 can determine the filtering information based on the AF authorization data or based on other local configuration parameters in the AIOTF 1112.

By way of another example, in some cases filter information (also referred to as requested filter information) provided by the AF 1102 in the information about the target AIoT Device is too coarse and may lead to paging a huge number of AIoT devices. In such cases the many AIoT devices may respond to the paging message and congestion may happen. In order to avoid the possible congestions, the AIOTF 1112 may change the requested filter information provided by the AF 1102 in order to reduce the number of responding AIoT devices. Such situations may happen in case of example 700 of FIG. 7 where the whole “Domain information” is included in the requested filter information and a large number of AIoT devices are part of the domain. The AIOTF 1112 may increase the length of the requested filter information (e.g., limit the number of AIoT devices that would potentially match to the filter information). In other words, the AIOTF 1112 may create multiple filter information from coarse requested filter information. By this, the AIOTF 1112 may send to the AIoT readers 1106 several inventory request messages for each of the multiple filter information based on the coarse requested filter information.

If the AIOTF 1112 creates or changes the filter information as described at 1126 (step 4c), the AIOTF 1112 also stores in the AIoT device context the original AIoT Identification Information as received at 1110 (step 1) or 1118 (step 3). The AIOTF 1112 considers the original AIoT Identification Information when processing the AIOT NAS message in step 10 below.

At 1128 (step 5), the AIOTF 1112 sends an AIoT Inventory Service Response to the NEF 1116 (or directly to the AF 1102) including the result (e.g., accept or reject) for the AIoT Inventory service operation request based on the outcome of step 4a, 4b or 4c above.

At 1130 (step 6), the NEF 1116 sends the AIoT service operation response to the AF 1102, including the accept or reject result for the AIoT Inventory service operation request.

At 1132 (step 7), the AIOTF 1112 sends the Inventory Request message to the selected RAN node (e.g., AIoT reader 1106) as its final destination. The message may include a Correlation ID, the AIoT device identification information to be included in the paging message, cryptographic nonce information (Nonce_nw) and assistance information to the selected NG-RAN (e.g., AIoT reader 1106). The Correlation ID is used by the NG-RAN in the Inventory Response message in step 9 below to the AIOTF 1112 by using the same Correlation ID. By this, the AIOTF 1112 can correlate the messages in step 7 and step 9. It should be noted that the cryptographic nonce information (Nonce_nw) is created in the network (e.g., in the ADM 1122) and may be used in the AIoT device as input information to create a new AIoT device temporary ID.

At 1134 (step 8), upon reception of the Inventory Request message from the AIOTF 1112, the AIoT reader(s) 1106 execute the inventory operation. The AIOT reader(s) 1106 broadcast the paging message that includes the AIoT identification information. The AIoT device 1104 determines whether the received AIoT device identification information (e.g., filter information) matches the corresponding part of the AIoT device permanent ID configured in the AIoT device 1104. If the AIoT device 1104 determines that there is a match, the AIoT device 1104 creates and sends a response to the paging message. The response may include an AIOT NAS message that includes at least one of the parameters: an AIoT device temporary ID, cryptographic nonce information created at the AIoT device 1104 (e.g., Nonce_dev), or message authentication code (MAC_dev). The AIoT device 1104 may create the AIoT device temporary ID in an internal hash functionality by considering as input parameters at least one of: AIoT device permanent ID, Nonce_nw, or cryptographic key pre-share with the network (may be assigned during the manufacturing process of the device). Alternatively, or additionally, the AIoT device 1104 may generate a message authentication code (MAC_dev) to be sent to the network.

At 1136 (step 9), the AIOT reader 1106 sends one or more inventory Report messages to the AIOTF 1112 including the Correlation ID (as per step 7 above), Reader ID and one or more AIOT NAS messages from the AIoT devices. The AIOTF 1112 stores the mapping between the Reader ID and AIoT device ID(s). There may be replies from multiple AIoT devices at 1136 (step 9), as the filter information used in the paging message in step 8 above may have matched to the AIoT device permanent IDs of several AIoT devices. In other words, the AIOTF 1112 may receive reply messages (e.g., AIoT NAS messages) from multiple AIoT devices where each reply contains a different device temporary ID.

At 1138 (step 10), the AIOTF 1112 performs a procedure to validate the Inventory Report message (e.g., received from the AIoT reader and which may contain one or more AIoT NAS messages from the AIoT devices), using locally stored AIoT device context or the AIOTF 1112 may request the ADM 1122 to verify the result message device profile data retrieved from the ADM 1122. The received one or more AIOT NAS messages from the AIoT devices may include an AIoT device temporary ID and additional cryptographic information from the device (e.g., Nonce_dev and/or MAC_dev). In one embodiment the AIOTF uses the locally stored AIoT device context (e.g., containing the original AIoT identification information received from the AF) and the AIOTF considers this original AIoT Identification Information when processing the received inventory responses like AIOT NAS message. For example, the AIOTF may translate back the AIoT Device ID based on the filter information applied to the inventory request message, or to aggregate or filter out the inventory report messages.

Alternatively, or additionally, the AIOTF 1112 may send a request message to the ADM 1122 and provide at least one of the following parameters: all available pairs of information from the AIOT NAS message [AIoT device temporary IDs and Nonce_dev, MAC_dev], an indication that the ADM 1122 is requested to provide the AIoT device permanent IDs corresponding to the AIoT device temporary IDs. If the AIOTF 1112 is to send a follow-up service request to the AIoT device (e.g., a command for read or write), the AIOTF 1112 may include an indication to the ADM 1122 to provide a new device temporary ID.

The ADM 1122 applies a hash functionality considering as input parameters e.g., AIoT device temporary ID, Nonce_dev, or MAC_dev and takes into account pre-shared cryptographic keys. The expected output of the verification information at the ADM 1122 is that the information from the AIOT NAS message is valid and corresponds to a AIoT device permanent ID. The ADM 1122 reports to the AIOTF 1112 the Permanent Device ID if the message was authentic. If the AIOTF 1112 determines that at least one received AIOT NAS message matches to the AIoT device permanent ID from step 3 above, the AIOTF 1112 determines that the AIoT device corresponding to the AIoT device permanent ID has replied to the service request. By this, the AIOTF 1112 has verified that the AIoT device is available under the AIoT reader ID as per step 9 above. Further, the AIOTF 1112 may perform a command procedure, if needed and requested by the AF 1102 in step 1 above. For this purpose, the AIOTF 1112 may send a request message to the ADM 1122 to provide an AIoT device temporary ID for the AIoT device permanent ID.

At 1140 (step 11), the AIOTF 1112 reports the progress of the AIoT inventory request to the NEF 1116 by sending the Naiotf_AIoT_Notify message including a list of one or more AIoT Device Permanent Identifiers. The AIOTF 1112 may send multiple reports. The AIOTF 1112 in the final Naiotf_AIoT_Notify message may indicate that this is the last report for this operation. If multiple AIOTFs 1112 are involved in the procedure, the NEF 1116 may receive the AIoT_Notify from multiple AIOTFs 1112. The AIOTF is expected to store a context for each AIoT device at least for the time duration from receiving the AIoT service request from the AF 1102 until the completion of the AIoT procedure and reporting back the result to the AF 1102.

At 1142 (step 12), when receiving the Naiotf_AIoT_Notify message from the AIOTF 1112, the NEF 1116 informs the AF 1102 of the outcome of the AIoT_Inventory request by sending the Nnef_AIoT_Notify message(s) including the AIoT Device Permanent Identifier(s). The NEF 1116 in the final Nnef_AIoT_Notify message indicates that it is the last report for this operation.

In one alternative to steps 11 and 12, the AIOTF 1112 may send the response message corresponding to the AIoT inventory request from step 1 directly to the AF 1102 (e.g., without including the NEF 1116).

The solution described in the signaling flow 1100 can be applied for public networks, e.g., PLMN, or for private networks, e.g., non-public network (NPN) or standalone NPN (SNPN).

It should be noted that one benefit of the solution in the signaling flow 1100 is that the AIOTF 1112 is able to apply anonymization of the AIoT device permanent ID by applying ID filter information. By applying filter information, the AIOTF protects the privacy of the AIoT device permanent ID and shortens the ID transmitted over the air. The latter result is achieved based on the assumption that the filter information is shorter than the complete AIoT device permanent ID.

In one or more implementations, at 1110 (step 1), the AF 1102 can provide to the network, e.g., AIOTF 1112, a requested time interval for performing the AIoT service operation. The AIOTF 1112 may be able to determine that the requested time interval is too short in order to perform the operation. In such cases, the AIOTF 1112 may send a reject indication in the message to the AF 1102 at 1128 (step 5) and at 1130 (step 6). The AIOTF 1112 may include a corresponding reject cause value that indicates the reason for rejection being too short time interval to perform the AIoT service operation. In addition, the AIOTF 1112 may send to the AF 1102 in the reject message a recommended minimum time for performing the service operation. The recommended minimum time interval may be locally configured in the AIOTF 1112 or may be determined based on other parameters, e.g., size of the target service area, or expected number of AIoT devices to respond to the AIoT service request message.

In one example, the requested time interval may be too short in order to perform the operation in situations in which the target service area is large (e.g., many AIoT readers will be involved in the service operation) or when filtering information is used in the AIoT device identification information. The filtering information may result in a high number AIoT devices that are expected to respond to the AIoT service request message. In those cases, a longer amount of time is required by the network to read all the AIoT devices, and thus, the time required for performing the AIoT service operation is higher.

Accordingly, returning to FIG. 1, determining that the received AIoT device identification information contains a complete AIoT device permanent ID and that this ID is to be anonymized in order to protect the device privacy is discussed herein. Applying filter information (e.g., filter mask) on the complete AIoT device permanent ID is also discussed herein. Transmitting a service request message to the AIoT reader including the filtering information is also discussed herein. Receiving one or more response messages from the AIoT device and performing a verification procedure with the ADM to determining whether the requested AIoT devices (e.g., as per step 1 and 3 of the signaling flow 1100) have replied is also discussed herein.

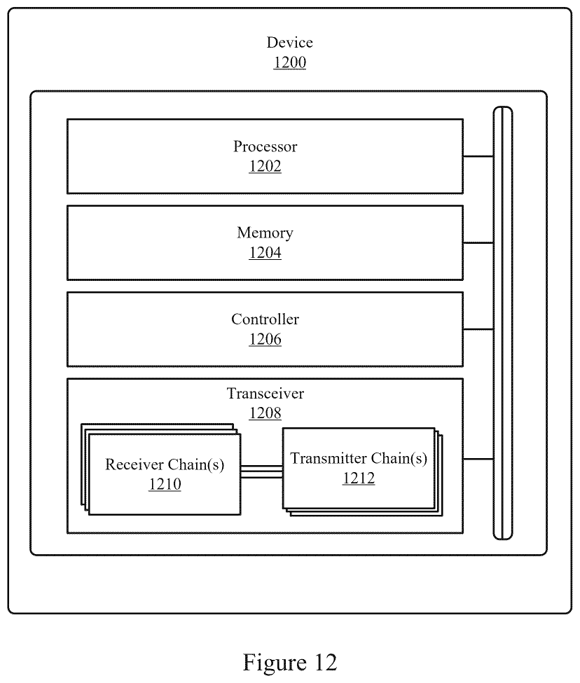

FIG. 12 illustrates an example of a device 1200 in accordance with aspects of the present disclosure. The device 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces. The device 1200 may be a low power device (e.g., an Ambient IoT device), a UE, a wireless device associated with a carrier wave (e.g., an external carrier wave node as discussed above), and so forth.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the device 1200 to perform various functions of the present disclosure.

The memory 1204 may include volatile or non-volatile memory. The memory 1204 may store computer-readable, computer-executable code including instructions when executed by the processor 1202 cause the device 1200 to perform various functions described herein. The code may be stored in a non-transitory computer-readable medium such as the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the device 1200 to perform one or more of the functions described herein (e.g., executing, by the processor 1202, instructions stored in the memory 1204). For example, the processor 1202 may support wireless communication at the device 1200 in accordance with examples as disclosed herein. The device 1200 may be configured to or operable to support a means for receiving a message that includes information generated based at least in part on one or more parameters; and transmitting, based at least in part on the information matching a permanent identifier (ID) of the device, a response to the message.

Additionally, the device 1200 may be configured to support any one or combination of where the device comprises an AIoT device, and where the response to the message includes at least one of a temporary ID of the device, cryptographic nonce information, or a message authentication code; where the one or more parameters include a starting bit location and a number of bits that are indicative of an ID type field and a domain information field included in the permanent ID of the device; where the one or more parameters include a starting bit location and a number of bits that are indicative of a third party identifier field included in the permanent ID of the device; where the one or more parameters include a first starting bit location and a first number of bits that are indicative of a first portion of the permanent ID of the device, and a second starting bit location and a second number of bits that are indicative of a second portion of the permanent ID of the device; where the first portion identifies a PLMN ID field of the permanent ID of the device and a NID field of the permanent ID of the device, and where the second portion identifies part of an identification information field of the permanent ID of the device; where the one or more parameters include a starting bit location and a first number of bits that are indicative of a third party identifier field and a portion of an identification information field included in the permanent ID of the device.

Additionally, or alternatively, the device 1200 may support at least one memory (e.g., the memory 1204) and at least one processor (e.g., the processor 1202) coupled with the at least one memory and configured to cause the device to: receive a message that includes information generated based at least in part on one or more parameters; and transmit, based at least in part on the information matching a permanent ID of the device, a response to the message.

Additionally, the device 1200 may be configured to support any one or combination of the device comprises an AIoT device, and where the response to the message includes at least one of a temporary ID of the device, cryptographic nonce information, or a message authentication code; where the one or more parameters include a starting bit location and a number of bits that are indicative of an ID type field and a domain information field included in the permanent ID of the device; where the one or more parameters include a starting bit location and a number of bits that are indicative of a third party identifier field included in the permanent ID of the device; where the one or more parameters include a first starting bit location and a first number of bits that are indicative of a first portion of the permanent ID of the device, and a second starting bit location and a second number of bits that are indicative of a second portion of the permanent ID of the device; where the first portion identifies a PLMN ID field of the permanent ID of the device and a NID field of the permanent ID of the device, and where the second portion identifies part of an identification information field of the permanent ID of the device; where the one or more parameters include a starting bit location and a first number of bits that are indicative of a third party identifier field and a portion of an identification information field included in the permanent ID of the device.

In some implementations, the processor 1202 and the memory 1204 coupled with the processor 1202 may be configured to cause the device 1200 to perform one or more of the functions described herein (e.g., executing, by the processor 1202, instructions stored in the memory 1204). For example, the processor 1202 may support wireless communication at the device 1200 in accordance with examples as disclosed herein. The device 1200 may be configured to or operable to support a means for receiving a message that includes AIoT filtered information; and transmitting, based at least in part on the AIoT filtered information matching a permanent ID of the device, a response to the message.

Additionally, the device 1200 may be configured to support any one or combination of where the device comprises an AIoT device, and where the response to the message includes at least one of a temporary ID of the device, cryptographic nonce information, or a message authentication code; where the AIoT filtered information is generated based at least in part on a filter start location and a filter length that identifies an ID type and domain information included in the permanent ID of the device; where the AIoT filtered information is generated based at least in part on a filter start location and a filter length that identifies a third party identifier included in the permanent ID of the device; where the AIoT filtered information is generated based at least in part on a first filter start location and a first filter length that identifies a first portion of the permanent ID of the device, and a second filter start location and a second filter length that identifies a second portion of the permanent ID of the device; where the first portion identifies a PLMN ID and a NID of the permanent ID of the device, and where the second portion identifies part of identification information of the permanent ID of the device; where the AIoT filtered information is generated based at least in part on a filter start location and a filter length that identifies a third party identifier and a portion of identification information included in the permanent ID of the device.

Additionally, or alternatively, the device 1200 may support at least one memory (e.g., the memory 1204) and at least one processor (e.g., the processor 1202) coupled with the at least one memory and configured to cause the device to: receive a message that includes AIoT filtered information; and transmit, based at least in part on the AIoT filtered information matching a permanent ID of the device, a response to the message.

Additionally, the device 1200 may be configured to support any one or combination of the device comprises an AIoT device, and where the response to the message includes at least one of a temporary ID of the device, cryptographic nonce information, or a message authentication code; where the AIoT filtered information is generated based at least in part on a filter start location and a filter length that identifies an ID type and domain information included in the permanent ID of the device; where the AIoT filtered information is generated based at least in part on a filter start location and a filter length that identifies a third party identifier included in the permanent ID of the device; where the AIoT filtered information is generated based at least in part on a first filter start location and a first filter length that identifies a first portion of the permanent ID of the device, and a second filter start location and a second filter length that identifies a second portion of the permanent ID of the device; where the first portion identifies a PLMN ID and a NID of the permanent ID of the device, and where the second portion identifies part of identification information of the permanent ID of the device; where the AIoT filtered information is generated based at least in part on a filter start location and a filter length that identifies a third party identifier and a portion of identification information included in the permanent ID of the device.

The controller 1206 may manage input and output signals for the device 1200. The controller 1206 may also manage peripherals not integrated into the device 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the device 1200 may include at least one transceiver 1208. In some other implementations, the device 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas to receive a signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

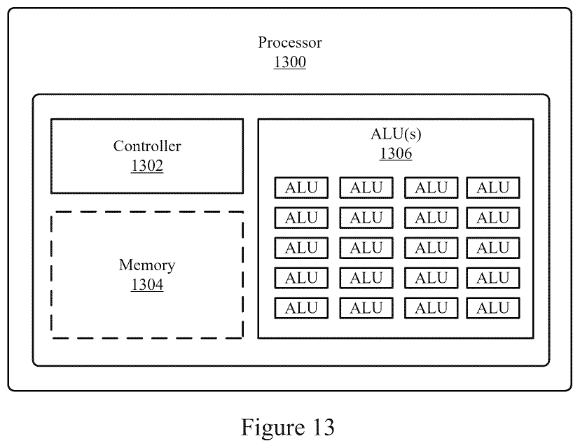

FIG. 13 illustrates an example of a processor 1300 in accordance with aspects of the present disclosure. The processor 1300 may be an example of a processor configured to perform various operations in accordance with examples as described herein. The processor 1300 may include a controller 1302 configured to perform various operations in accordance with examples as described herein. The processor 1300 may optionally include at least one memory 1304, which may be, for example, an L1/L2/L3 cache. Additionally, or alternatively, the processor 1300 may optionally include one or more arithmetic-logic units (ALUs) 1306. One or more of these components may be in electronic communication or otherwise coupled (e.g., operatively, communicatively, functionally, electronically, electrically) via one or more interfaces (e.g., buses).

The processor 1300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1302 may be configured to manage and coordinate various operations (e.g., signaling, receiving, obtaining, retrieving, transmitting, outputting, forwarding, storing, determining, identifying, accessing, writing, reading) of the processor 1300 to cause the processor 1300 to support various operations in accordance with examples as described herein. For example, the controller 1302 may operate as a control unit of the processor 1300, generating control signals that manage the operation of various components of the processor 1300. These control signals include enabling or disabling functional units, selecting data paths, initiating memory access, and coordinating timing of operations.

The controller 1302 may be configured to fetch (e.g., obtain, retrieve, receive) instructions from the memory 1304 and determine subsequent instruction(s) to be executed to cause the processor 1300 to support various operations in accordance with examples as described herein. The controller 1302 may be configured to track memory addresses of instructions associated with the memory 1304. The controller 1302 may be configured to decode instructions to determine the operation to be performed and the operands involved. For example, the controller 1302 may be configured to interpret the instruction and determine control signals to be output to other components of the processor 1300 to cause the processor 1300 to support various operations in accordance with examples as described herein. Additionally, or alternatively, the controller 1302 may be configured to manage flow of data within the processor 1300. The controller 1302 may be configured to control transfer of data between registers, ALUs 1306, and other functional units of the processor 1300.

The memory 1304 may include one or more caches (e.g., memory local to or included in the processor 1300 or other memory, such as RAM, ROM, DRAM, SDRAM, SRAM, MRAM, flash memory, etc. In some implementations, the memory 1304 may reside within or on a processor chipset (e.g., local to the processor 1300). In some other implementations, the memory 1304 may reside external to the processor chipset (e.g., remote to the processor 1300).

The memory 1304 may store computer-readable, computer-executable code including instructions that, when executed by the processor 1300, cause the processor 1300 to perform various functions described herein. The code may be stored in a non-transitory computer-readable medium such as system memory or another type of memory. The controller 1302 and/or the processor 1300 may be configured to execute computer-readable instructions stored in the memory 1304 to cause the processor 1300 to perform various functions. For example, the processor 1300 and/or the controller 1302 may be coupled with or to the memory 1304, the processor 1300, and the controller 1302, and may be configured to perform various functions described herein. In some examples, the processor 1300 may include multiple processors and the memory 1304 may include multiple memories. One or more of the multiple processors may be coupled with one or more of the multiple memories, which may, individually or collectively, be configured to perform various functions herein.

The one or more ALUs 1306 may be configured to support various operations in accordance with examples as described herein. In some implementations, the one or more ALUs 1306 may reside within or on a processor chipset (e.g., the processor 1300). In some other implementations, the one or more ALUs 1306 may reside external to the processor chipset (e.g., the processor 1300). One or more ALUs 1306 may perform one or more computations such as addition, subtraction, multiplication, and division on data. For example, one or more ALUs 1306 may receive input operands and an operation code, which determines an operation to be executed. One or more ALUs 1306 may be configured with a variety of logical and arithmetic circuits, including adders, subtractors, shifters, and logic gates, to process and manipulate the data according to the operation. Additionally, or alternatively, the one or more ALUs 1306 may support logical operations such as AND, OR, exclusive-OR (XOR), not-OR (NOR), and not-AND (NAND), enabling the one or more ALUs 1306 to handle conditional operations, comparisons, and bitwise operations.

The processor 1300 may support wireless communication in accordance with examples as disclosed herein. The processor 1300 may be configured to or operable to support at least one controller (e.g., the controller 1302) coupled with at least one memory (e.g., the memory 1304) and configured to cause the processor to: receive a message that includes information generated based at least in part on one or more parameters; and transmit, based at least in part on the information matching a permanent ID of the device, a response to the message.

Additionally, the processor 1300 may be configured to or operable to support any one or combination of where the device comprises an AIoT device, and where the response to the message includes at least one of a temporary ID of the device, cryptographic nonce information, or a message authentication code; where the one or more parameters include a starting bit location and a number of bits that are indicative of an ID type field and a domain information field included in the permanent ID of the device; where the one or more parameters include a starting bit location and a number of bits that are indicative of a third party identifier field included in the permanent ID of the device; where the one or more parameters include a first starting bit location and a first number of bits that are indicative of a first portion of the permanent ID of the device, and a second starting bit location and a second number of bits that are indicative of a second portion of the permanent ID of the device; where the first portion identifies a PLMN ID field of the permanent ID of the device and a NID field of the permanent ID of the device, and where the second portion identifies part of an identification information field of the permanent ID of the device; where the one or more parameters include a starting bit location and a first number of bits that are indicative of a third party identifier field and a portion of an identification information field included in the permanent ID of the device.

The processor 1300 may support wireless communication in accordance with examples as disclosed herein. The processor 1300 may be configured to or operable to support at least one controller (e.g., the controller 1302) coupled with at least one memory (e.g., the memory 1304) and configured to cause the processor to: receive an AIoT service request that includes at least one AIoT device ID; determine one or more parameters for modifying the at least one AIoT device ID for privacy protection; and transmit information based at least in part on the one or more parameters.

Additionally, the processor 1300 may be configured to or operable to support any one or combination of where to determine the one or more parameters, the at least one processor is operable to cause the NE to reduce a number of AIoT devices that are identified by the one or more parameters; where the at least one AIoT device ID comprises at least one AIoT device permanent ID; where the at least one AIoT device ID is identified by filter information included in the AIoT service request; where to transmit the information, the at least one processor is operable to cause the NE to transmit the information to an AIoT reader device; where the at least one processor is operable to cause the NE to receive a response from an AIoT reader device that includes one or more device temporary IDs of one or more AIoT devices identified by the information; where the at least one processor is operable to cause the NE to transmit a request message that includes an indication to provide at least one AIoT device permanent ID corresponding to the at least one AIoT device ID, or an indication to provide at least one AIoT device temporary ID corresponding to the at least one AIoT device ID; where the at least one processor is operable to cause the NE to receive the at least one AIoT device permanent ID, or the at least one AIoT device temporary ID; where the one or more parameters include a starting bit location and a number of bits that are indicative of an ID type field and a domain information field included in an AIoT device permanent ID corresponding to the at least one AIoT device; where the one or more parameters include a starting bit location and a number of bits that are indicative of a third party identifier field included in an AIoT device permanent ID corresponding to the at least one AIoT device; where the one or more parameters include a first starting bit location and a first number of bits that are indicative of a first portion of an AIoT device permanent ID corresponding to the at least one AIoT device, and a second starting bit location and a second number of bits that are indicative of a second portion of the AIoT device permanent ID corresponding to the at least one AIoT device; where the first portion identifies a PLMN ID field of the AIoT device permanent ID and a NID field of the AIoT device permanent ID, and where the second portion identifies part of an identification information field of the AIoT device permanent ID; where the one or more parameters include a starting bit location and a first number of bits that are indicative of a third party identifier field and a portion of an identification information field included in an AIoT device permanent ID corresponding to the at least one AIoT device.

The processor 1300 may support wireless communication in accordance with examples as disclosed herein. The processor 1300 may be configured to or operable to support at least one controller (e.g., the controller 1302) coupled with at least one memory (e.g., the memory 1304) and configured to cause the processor to: receive a message that includes AIoT filtered information; and transmit, based at least in part on the AIoT filtered information matching a permanent ID of the device, a response to the message.

Additionally, the processor 1300 may be configured to or operable to support any one or combination of the device comprises an AIoT device, and where the response to the message includes at least one of a temporary ID of the device, cryptographic nonce information, or a message authentication code; where the AIoT filtered information is generated based at least in part on a filter start location and a filter length that identifies an ID type and domain information included in the permanent ID of the device; where the AIoT filtered information is generated based at least in part on a filter start location and a filter length that identifies a third party identifier included in the permanent ID of the device; where the AIoT filtered information is generated based at least in part on a first filter start location and a first filter length that identifies a first portion of the permanent ID of the device, and a second filter start location and a second filter length that identifies a second portion of the permanent ID of the device; where the first portion identifies a PLMN ID and a NID of the permanent ID of the device, and where the second portion identifies part of identification information of the permanent ID of the device; where the AIoT filtered information is generated based at least in part on a filter start location and a filter length that identifies a third party identifier and a portion of identification information included in the permanent ID of the device.

The processor 1300 may support wireless communication in accordance with examples as disclosed herein. The processor 1300 may be configured to or operable to support at least one controller (e.g., the controller 1302) coupled with at least one memory (e.g., the memory 1304) and configured to cause the processor to: receive an AIoT service request that includes at least one AIoT device ID information; generate filtered information based at least in part on filter information applied to the at least one AIoT device ID information; and transmit the filtered information.

Additionally, the processor 1300 may be configured to or operable to support any one or combination of where to generate the filtered information, the at least one controller is operable to cause the processor to reduce a number of AIoT devices that respond to the transmitted filtered information; where the at least one AIoT device ID information comprises at least one AIoT device permanent ID or requested filter information; where to transmit the filtered information, the at least one controller is operable to cause the processor to transmit the filtered information to an AIoT reader device; where the at least one controller is operable to cause the processor to receive a response from an AIoT reader device that includes one or more device temporary IDs; where the at least one controller is operable to cause the processor to transmit a request message that includes an indication to provide at least one AIoT device permanent ID, or an indication to provide at least one new device temporary ID; where the at least one controller is operable to cause the processor to receive the at least one AIoT device permanent ID, or the at least one new device temporary ID; where the filter information includes a filter start location and a filter length that identifies an ID type and domain information included in an AIoT device permanent ID corresponding to the at least one AIoT device; where the filter information includes a filter start location and a filter length that identifies a third party identifier included in an AIoT device permanent ID corresponding to the at least one AIoT device; where the filter information includes a first filter start location and a first filter length that identifies a first portion of an AIoT device permanent ID corresponding to the at least one AIoT device, and a second filter start location and a second filter length that identifies a second portion of the AIoT device permanent ID corresponding to the at least one AIoT device; where the first portion identifies a PLMN ID and a NID of the AIoT device permanent ID, and where the second portion identifies part of identification information of the AIoT device permanent ID; where the filter information includes a filter start location and a filter length that identifies a third party identifier and a portion of identification information included in an AIoT device permanent ID corresponding to the at least one AIoT device.

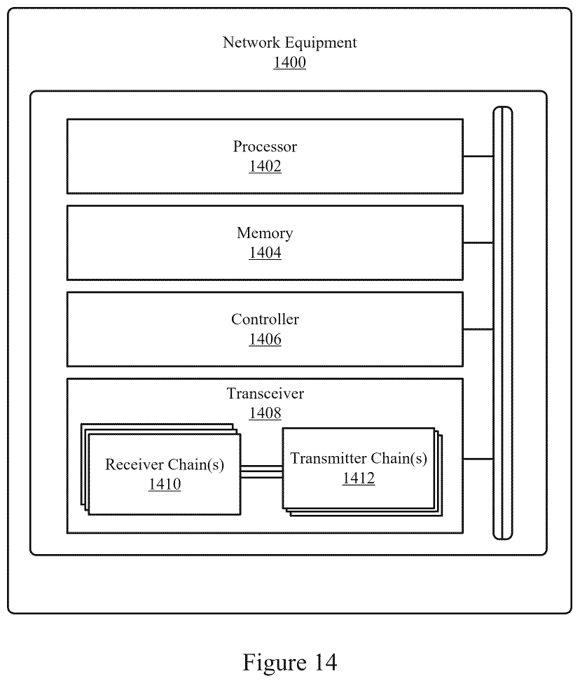

FIG. 14 illustrates an example of an NE 1400 in accordance with aspects of the present disclosure. The NE 1400 may include a processor 1402, a memory 1404, a controller 1406, and a transceiver 1408. The processor 1402, the memory 1404, the controller 1406, or the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, or the transceiver 1408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1402 may include an intelligent hardware device (e.g., a general-purpose processor, a DSP, a CPU, an ASIC, an FPGA, or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the NE 1400 to perform various functions of the present disclosure.

The memory 1404 may include volatile or non-volatile memory. The memory 1404 may store computer-readable, computer-executable code including instructions when executed by the processor 1402 cause the NE 1400 to perform various functions described herein. The code may be stored in a non-transitory computer-readable medium such as the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1402 and the memory 1404 coupled with the processor 1402 may be configured to cause the NE 1400 to perform one or more of the functions described herein (e.g., executing, by the processor 1402, instructions stored in the memory 1404). For example, the processor 1402 may support wireless communication at the NE 1400 in accordance with examples as disclosed herein. The NE 1400 may be configured to support a means for receiving an AIoT service request that includes at least one AIoT device ID; determining one or more parameters for modifying the at least one AIoT device ID for privacy protection; and transmitting information based at least in part on the one or more parameters.

Additionally, the NE 1400 may be configured to support any one or combination of the determining the one or more parameters comprises reducing a number of AIoT devices that are identified by the one or more parameters; where the at least one AIoT device ID comprises at least one AIoT device permanent ID; where the at least one AIoT device ID is identified by filter information included in the AIoT service request; where transmitting the information comprises transmitting the information to an AIoT reader device; further including receiving a response from an AIoT reader device that includes one or more device temporary IDs of one or more AIoT devices identified by the information; further including transmitting a request message that includes an indication to provide at least one AIoT device permanent ID corresponding to the at least one AIoT device ID, or an indication to provide at least one AIoT device temporary ID corresponding to the at least one AIoT device ID; further including receiving the at least one AIoT device permanent ID, or the at least one AIoT device temporary ID; where the one or more parameters include a starting bit location and a number of bits that are indicative of an ID type field and a domain information field included in an AIoT device permanent ID corresponding to the at least one AIoT device; where the one or more parameters include a starting bit location and a number of bits that are indicative of a third party identifier field included in an AIoT device permanent ID corresponding to the at least one AIoT device; where the one or more parameters include a first starting bit location and a first number of bits that are indicative of a first portion of an AIoT device permanent ID corresponding to the at least one AIoT device, and a second starting bit location and a second number of bits that are indicative of a second portion of the AIoT device permanent ID corresponding to the at least one AIoT device; where the first portion identifies a PLMN ID field of the AIoT device permanent ID and a NID field of the AIoT device permanent ID, and where the second portion identifies part of an identification information field of the AIoT device permanent ID; where the one or more parameters include a starting bit location and a first number of bits that are indicative of a third party identifier field and a portion of an identification information field included in an AIoT device permanent ID corresponding to the at least one AIoT device.

Additionally, or alternatively, the NE 1400 may support at least one memory (e.g., the memory 1404) and at least one processor (e.g., the processor 1402) coupled with the at least one memory and configured to cause the NE to: receive an AIoT service request that includes at least one AIoT device ID; determine one or more parameters for modifying the at least one AIoT device ID for privacy protection; and transmit information based at least in part on the one or more parameters.

Additionally, the NE 1400 may be configured to support any one or combination of to determine the one or more parameters, the at least one processor is operable to cause the NE to reduce a number of AIoT devices that are identified by the one or more parameters; where the at least one AIoT device ID comprises at least one AIoT device permanent ID; where the at least one AIoT device ID is identified by filter information included in the AIoT service request; where to transmit the information, the at least one processor is operable to cause the NE to transmit the information to an AIoT reader device; where the at least one processor is operable to cause the NE to receive a response from an AIoT reader device that includes one or more device temporary IDs of one or more AIoT devices identified by the information; where the at least one processor is operable to cause the NE to transmit a request message that includes an indication to provide at least one AIoT device permanent ID corresponding to the at least one AIoT device ID, or an indication to provide at least one AIoT device temporary ID corresponding to the at least one AIoT device ID; where the at least one processor is operable to cause the NE to receive the at least one AIoT device permanent ID, or the at least one AIoT device temporary ID; where the one or more parameters include a starting bit location and a number of bits that are indicative of an ID type field and a domain information field included in an AIoT device permanent ID corresponding to the at least one AIoT device; where the one or more parameters include a starting bit location and a number of bits that are indicative of a third party identifier field included in an AIoT device permanent ID corresponding to the at least one AIoT device; where the one or more parameters include a first starting bit location and a first number of bits that are indicative of a first portion of an AIoT device permanent ID corresponding to the at least one AIoT device, and a second starting bit location and a second number of bits that are indicative of a second portion of the AIoT device permanent ID corresponding to the at least one AIoT device; where the first portion identifies a PLMN ID field of the AIoT device permanent ID and a NID field of the AIoT device permanent ID, and where the second portion identifies part of an identification information field of the AIoT device permanent ID; where the one or more parameters include a starting bit location and a first number of bits that are indicative of a third party identifier field and a portion of an identification information field included in an AIoT device permanent ID corresponding to the at least one AIoT device.

In some implementations, the processor 1402 and the memory 1404 coupled with the processor 1402 may be configured to cause the NE 1400 to perform one or more of the functions described herein (e.g., executing, by the processor 1402, instructions stored in the memory 1404). For example, the processor 1402 may support wireless communication at the NE 1400 in accordance with examples as disclosed herein. The NE 1400 may be configured to support a means for receiving an AIoT service request that includes at least one AIoT device ID information; generating filtered information based at least in part on filter information applied to the at least one AIoT device information; and transmitting the filtered information.

Additionally, the NE 1400 may be configured to support any one or combination of where generating the filtered information further comprises reducing a number of AIoT devices that respond to the transmitted filtered information; where the at least one AIoT device ID information comprises at least one AIoT device permanent ID or requested filter information; where transmitting the filtered information further comprises transmitting the filtered information to an AIoT reader device; further including receiving a response from an AIoT reader device that includes one or more device temporary IDs; further including transmitting a request message that includes an indication to provide at least one AIoT device permanent ID, or an indication to provide at least one new device temporary ID; further including receiving the at least one AIoT device permanent ID, or the at least one new device temporary ID; where the filter information includes a filter start location and a filter length that identifies an ID type and domain information included in an AIoT device permanent ID corresponding to the at least one AIoT device; where the filter information includes a filter start location and a filter length that identifies a third party identifier included in an AIoT device permanent ID corresponding to the at least one AIoT device; where the filter information includes a first filter start location and a first filter length that identifies a first portion of an AIoT device permanent ID corresponding to the at least one AIoT device, and a second filter start location and a second filter length that identifies a second portion of the AIoT device permanent ID corresponding to the at least one AIoT device; where the first portion identifies a PLMN ID and a NID of the AIoT device permanent ID, and where the second portion identifies part of identification information of the AIoT device permanent ID; where the filter information includes a filter start location and a filter length that identifies a third party identifier and a portion of identification information included in an AIoT device permanent ID corresponding to the at least one AIoT device.

Additionally, or alternatively, the NE 1400 may support at least one memory (e.g., the memory 1404) and at least one processor (e.g., the processor 1402) coupled with the at least one memory and configured to cause the NE to: receive an AIoT service request that includes at least one AIoT device ID information; generate filtered information based at least in part on filter information applied to the at least one AIoT device ID information; and transmit the filtered information.

Additionally, the NE 1400 may be configured to support any one or combination of to generate the filtered information, the at least one processor is operable to cause the NE to reduce a number of AIoT devices that respond to the transmitted filtered information; where the at least one AIoT device ID information comprises at least one AIoT device permanent ID or requested filter information; where to transmit the filtered information, the at least one processor is operable to cause the NE to transmit the filtered information to an AIoT reader device; where the at least one processor is operable to cause the NE to receive a response from an AIoT reader device that includes one or more device temporary IDs; where the at least one processor is operable to cause the NE to transmit a request message that includes an indication to provide at least one AIoT device permanent ID, or an indication to provide at least one new device temporary ID; where the at least one processor is operable to cause the NE to receive the at least one AIoT device permanent ID, or the at least one new device temporary ID; where the filter information includes a filter start location and a filter length that identifies an ID type and domain information included in an AIoT device permanent ID corresponding to the at least one AIoT device; where the filter information includes a filter start location and a filter length that identifies a third party identifier included in an AIoT device permanent ID corresponding to the at least one AIoT device; where the filter information includes a first filter start location and a first filter length that identifies a first portion of an AIoT device permanent ID corresponding to the at least one AIoT device, and a second filter start location and a second filter length that identifies a second portion of the AIoT device permanent ID corresponding to the at least one AIoT device; where the first portion identifies a PLMN ID and a NID of the AIoT device permanent ID, and where the second portion identifies part of identification information of the AIoT device permanent ID; where the filter information includes a filter start location and a filter length that identifies a third party identifier and a portion of identification information included in an AIoT device permanent ID corresponding to the at least one AIoT device.

The controller 1406 may manage input and output signals for the NE 1400. The controller 1406 may also manage peripherals not integrated into the NE 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the NE 1400 may include at least one transceiver 1408. In some other implementations, the NE 1400 may have more than one transceiver 1408. The transceiver 1408 may represent a wireless transceiver. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas to receive a signal over the air or wireless medium. The receiver chain 1410 may include at least one amplifier (e.g., a low-noise amplifier (LNA)) configured to amplify the received signal. The receiver chain 1410 may include at least one demodulator configured to demodulate the receive signal and obtain the transmitted data by reversing the modulation technique applied during transmission of the signal. The receiver chain 1410 may include at least one decoder for decoding the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

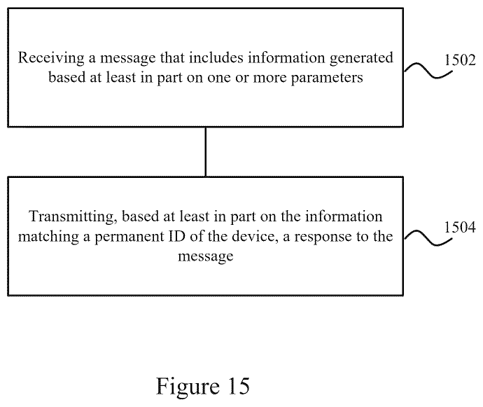

FIG. 15 illustrates a flowchart of a method in accordance with aspects of the present disclosure. The operations of the method may be implemented by a device as described herein, such as a UE, an Ambient IoT device, or a low power device. In some implementations, the UE, Ambient IoT device, or low power device may execute a set of instructions to control the function elements of the UE, Ambient IoT device, or low power device to perform the described functions.

At 1502, the method may include receiving a message that includes information generated based at least in part on one or more parameters. The operations of 1502 may be performed in accordance with examples as described herein. In some implementations, aspects of the operations of 1502 may be performed by a device as described with reference to FIG. 12.

At 1504, the method may include transmitting, based at least in part on the information matching a permanent ID of the device, a response to the message. The operations of 1504 may be performed in accordance with examples as described herein. In some implementations, aspects of the operations of 1504 may be performed by a device as described with reference to FIG. 12.

It should be noted that the method described herein describes a possible implementation, and that the operations and the steps may be rearranged or otherwise modified and that other implementations are possible.

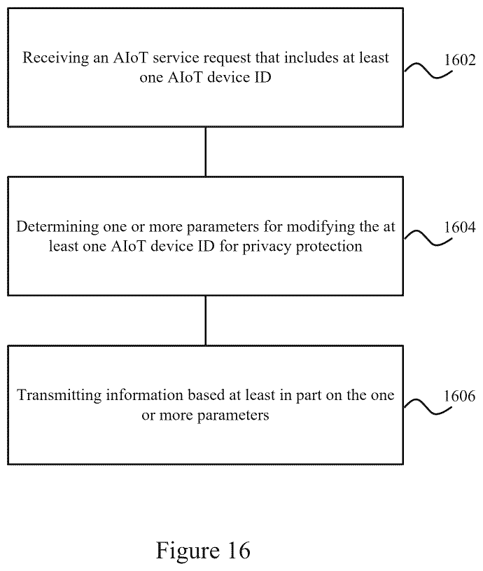

FIG. 16 illustrates a flowchart of a method in accordance with aspects of the present disclosure. The operations of the method may be implemented by an NE as described herein. In some implementations, the NE may execute a set of instructions to control the function elements of the NE to perform the described functions.

At 1602, the method may include receiving an AIoT service request that includes at least one AIoT device ID. The operations of 1602 may be performed in accordance with examples as described herein. In some implementations, aspects of the operations of 1602 may be performed by an NE as described with reference to FIG. 14.

At 1604, the method may include determining one or more parameters for modifying the at least one AIoT device ID for privacy protection. The operations of 1604 may be performed in accordance with examples as described herein. In some implementations, aspects of the operations of 1604 may be performed by an NE as described with reference to FIG. 14.

At 1606, the method may include transmitting information based at least in part on the one or more parameters. The operations of 1606 may be performed in accordance with examples as described herein. In some implementations, aspects of the operations of 1606 may be performed an NE as described with reference to FIG. 14.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network equipment (NE) for wireless communication, comprising:
at least one memory; and
at least one processor coupled with the at least one memory and operable to cause the NE to:
receive an ambient Internet of things (AIoT) service request that includes at least one AIoT device identifier (ID);
determine one or more parameters for modifying the at least one AIoT device ID for privacy protection; and
transmit information based at least in part on the one or more parameters.

2. The NE of claim 1, wherein to determine the one or more parameters, the at least one processor is operable to cause the NE to reduce a number of AIoT devices that are identified by the one or more parameters.

3. The NE of claim 1, wherein the at least one AIoT device ID comprises at least one AIoT device permanent ID.

4. The NE of claim 1, wherein the at least one AIoT device ID is identified by filter information included in the AIoT service request.

5. The NE of claim 1, wherein to transmit the information, the at least one processor is operable to cause the NE to transmit the information to an AIoT reader device.

6. The NE of claim 1, wherein the at least one processor is operable to cause the NE to receive a response from an AIoT reader device that includes one or more device temporary IDs of one or more AIoT devices identified by the information.

7. The NE of claim 1, wherein the at least one processor is operable to cause the NE to transmit a request message that includes an indication to provide at least one AIoT device permanent ID corresponding to the at least one AIoT device ID, or an indication to provide at least one AIoT device temporary ID corresponding to the at least one AIoT device ID.

8. The NE of claim 7, wherein the at least one processor is operable to cause the NE to receive the at least one AIoT device permanent ID, or the at least one AIoT device temporary ID.

9. The NE of claim 1, wherein the one or more parameters include a starting bit location and a number of bits that are indicative of an ID type field and a domain information field included in an AIoT device permanent ID corresponding to the at least one AIoT device.

10. The NE of claim 1, wherein the one or more parameters include a starting bit location and a number of bits that are indicative of a third party identifier field included in an AIoT device permanent ID corresponding to the at least one AIoT device.

11. The NE of claim 1, wherein the one or more parameters include a first starting bit location and a first number of bits that are indicative of a first portion of an AIoT device permanent ID corresponding to the at least one AIoT device, and a second starting bit location and a second number of bits that are indicative of a second portion of the AIoT device permanent ID corresponding to the at least one AIoT device.

12. The NE of claim 11, wherein the first portion identifies a public land mobile network (PLMN) ID field of the AIoT device permanent ID and a network identifier (NID) field of the AIoT device permanent ID, and wherein the second portion identifies part of an identification information field of the AIoT device permanent ID.

13. The NE of claim 1, wherein the one or more parameters include a starting bit location and a first number of bits that are indicative of a third party identifier field and a portion of an identification information field included in an AIoT device permanent ID corresponding to the at least one AIoT device.

14. A device for wireless communication, comprising:
at least one memory; and
at least one processor coupled with the at least one memory and operable to cause the device to:
receive a message that includes information generated based at least in part on one or more parameters; and
transmit, based at least in part on the information matching a permanent identifier (ID) of the device, a response to the message.

15. The device of claim 14, wherein the device comprises an AIoT device, and wherein the response to the message includes at least one of a temporary ID of the device, cryptographic nonce information, or a message authentication code.

16. The device of claim 14, wherein the one or more parameters include a starting bit location and a number of bits that are indicative of an ID type field and a domain information field included in the permanent ID of the device.

17. The device of claim 14, wherein the one or more parameters include a starting bit location and a number of bits that are indicative of a third party identifier field included in the permanent ID of the device.

18. The device of claim 14, wherein the one or more parameters include a first starting bit location and a first number of bits that are indicative of a first portion of the permanent ID of the device, and a second starting bit location and a second number of bits that are indicative of a second portion of the permanent ID of the device, wherein the first portion identifies a public land mobile network (PLMN) ID field of the permanent ID of the device and a network identifier (NID) field of the permanent ID of the device, and wherein the second portion identifies part of an identification information field of the permanent ID of the device.

19. A method performed by a network equipment (NE), the method comprising:
receiving an ambient Internet of things (AIoT) service request that includes at least one AIoT device identifier (ID);
determining one or more parameters for modifying the at least one AIoT device ID for privacy protection; and
transmitting information based at least in part on the one or more parameters.

20. A method performed by a device, the method comprising:
receiving a message that includes information generated based at least in part on one or more parameters; and
transmitting, based at least in part on the information matching a permanent identifier (ID) of the device, a response to the message.
